(19) United States
(12) Patent Application Publication
(10) Pub. No.: US 2008/0074406 A1
(43) Pub. Date: Mar. 27, 2008

(54) Panel display device

(76) Inventors: Kazuya Matsumoto, Kyoto (JP); Yoshihisa Hamahashi, Osaka (JP)

Correspondence Address: MCDERMOTT WILL & EMERY LLP, 600 13TH STREET, NW, WASHINGTON, DC, 20005-3096, US

(21) Appl. No.: 11/902,691

(22) Filed: Sep. 25, 2007

(30) Foreign Application Priority Data
Sep. 27, 2006 (JP) 2006-262129

(51) Int. Cl. G09G 5/00

(52) U.S. Cl. 345/204

(57) ABSTRACT

In a forward-direction fetching operation mode, each of display panel drive devices other than a last display panel drive device fetches display data upon the reception of a start signal. In the forward-direction fetching operation mode, the last display panel drive device fetches the display data upon the reception of the start signal. In a reverse-direction fetching operation mode, each of the display panel drive devices other than the last display panel drive device transmits the start signal to the immediately subsequent device in the forward direction upon the reception of the start signal. In the reverse-direction fetching operation mode, the last display panel drive device fetches the display data and transmits an enable signal to the immediately preceding device in the reverse direction upon the reception of the start signal. In the reverse-direction fetching operation mode, the display panel drive devices other than the last device fetches the display data and transmits the enable signal to the immediately preceding device in the reverse direction upon the reception of the enable signal.

### BACKGROUND OF THE INVENTION

1. Field of the Invention

The present invention relates to a panel display device wherein a plurality of display panel drive devices corresponding to a display panel such as a liquid crystal display panel is provided in parallel and cascade-connected. A cascade as used herein means a configuration in which a signal and data are received by one of the previous display panel drive devices and transmitted to the display panel drive device that follows.

2. Description of the Related Art

In recent years, a panel display device, such as a liquid crystal display device, is generally configured in such a manner that a plurality of display panel drive devices are cascade-connected. FIG. 21 is a block diagram illustrating a constitution of a conventional panel display device in which the cascade connection is adopted. A plurality of display panel drive devices A1, A2 and A3 are provided in parallel with respect to a display panel 4. A power supply P1 outputted from a power supply circuit 1 is applied to the display panel drive devices A1, A2 and A3, and a power supply P2 is applied to scan drivers 31, 32 and 33. Clock signals K1-K3, display data D1-D3, control signals C1-C3 and enable signals E1-E3, all of which are outputted from a controller 2, are inputted to the display panel drive devices A1, A2 and A3 in the cascade manner. The display panel drive device A1 which receives the enable signal E1 outputted from the controller 2 fetches the display data D1 outputted from the controller 2 in synchronization with the clock signal K1. After completing the fetch of the display data D1, the display panel drive device Al transmits the enable signal E2 and the display data D2 to the display panel drive device A2, and thereafter the transmission of the enable signal and the fetch of the display data are similarly repeated up to the last display panel drive device A3. Gradation voltages V1, V2 and V3 obtained when the display data D1, D2 and D3 are thus converted in the display panel drive devices A1, A2 and A3 are outputted to the display panel 4.

In the case of the panel display device of the cascade type in the foregoing description, the number of the display panel drive devices in the operable state can be limited in comparison to the stub-based panel display device wherein each of the display panel drive devices independently receives the signal and the data. As a result, power reduction and cost reduction can be achieved. Further, the cascade-type device is advantageous in terms of a wiring area, and a panel frame in the display panel can be thereby narrowed. These advantages are recited in, for example, Japanese Patent Laid-Open Publication No. 2001-324967 of the Japanese Patent Documents.

In the above-described conventional panel display device, the display data is fetched in only one direction from the display panel drive device A1 which first receives the enable signal outputted from the controller 2 to the last display panel drive device A3. As a recent trend, in most cases, a panel display device is capable of changing the directions in which the display data is fetched, and as a result, a bi-direction data fetching function is in increasing demand. However, the conventional configuration only allows the fetch of the display data to start from the display panel drive device A1 which first receives the signal outputted from the controller 2. In other words, it is not possible for the last display panel drive device A3 to start the fetch of the display data. In order to allow the display data to be fetched in two directions, a circuit for switching between the first display panel drive device A1 and the last display panel drive device A3 as a destination to which the signal outputted from the controller 2 is input and signals for controlling the operation of the circuit are necessary. Further, a wiring from the controller 2 to the last display panel drive device A3 is necessary other than a wiring from the controller 2 to the first display panel drive device A1. In other words, the bi-direction cascade connection inhibits the power reduction, cost reduction and downsizing of the panel frame, which are the intended advantages of the cascade connection.

### SUMMARY OF THE INVENTION

Therefore, a main object of the present invention is to provide a panel display device capable of achieving power reduction, cost reduction and downsizing of a panel frame when a bi-direction cascade transmission is realized.

A panel display device according to the present invention comprises:

a display panel;

a plurality of display panel drive devices cascade-connected to the display panel so as to drive-control the display panel; and

a controller for sequentially transmitting display data to the plurality of display panel drive devices, wherein

the plurality of display panel drive devices can switch between a forward-direction fetching operation mode for sequentially fetching the display data into the respective display panel drive devices along a forward direction of the plurality of display panel drive devices placed in parallel and a reverse-direction fetching operation mode for sequentially fetching the display data along a reverse direction of the plurality of display panel drive devices placed in parallel,

any of the display panel drive devices other than the last display panel drive device fetches the display data addressed to itself in response to the reception of a start signal from outside or the previous display panel drive device and transmits the start signal to the immediately subsequent display panel drive device in the forward direction in the forward-direction fetching operation mode,

the last display panel drive device fetches the display data addressed to itself in response the reception of the start signal in the forward-direction fetching operation mode,

any of the display panel drive devices other than the last display panel drive device fetches the display data addressed to itself in response to the reception of the start signal from outside or the previous display panel drive device and transmits the start signal to the immediately subsequent display panel drive device in the forward direction in the reverse-direction fetching operation mode,

the last display panel drive device fetches the display data addressed to itself in response the reception of the start signal and transmits an enable signal to the immediately preceding display panel drive device in the reverse direction in the reverse-direction fetching operation mode, and

any of the display panel drive devices other than the last display panel drive device fetches the display data addressed to itself in response to the reception of the enable signal and transmits the enable signal to the immediately preceding display panel drive device in the reverse direction in the reverse-direction fetching operation mode.

In the foregoing constitution, the first display panel drive device fetches the display data addressed to itself in response to the reception of the start signal from the controller and transmits the received start signal to the second display panel drive device in the forward-direction fetching operation mode. The second display panel drive device which received the start signal fetches the display data addressed to itself and transmits the start signal to the next display panel drive device. The foregoing operation is repeated, and the last display panel drive device which received the start signal fetches the display data addressed to itself. In the reverse-direction fetching operation mode, upon the reception of the start signal from the controller, the first display panel drive device transfers the received start signal to the second display panel drive device, wherein the display data is not fetched. The second display panel drive device which received the start signal further transfers the received start signal to the next display panel drive device, wherein the display data is not fetched. The foregoing operation is repeated, and the last display panel drive device which received the start signal fetches the display data addressed to itself and generates the enable signal and transmits the generated enable signal to the previous display panel drive device. The display panel drive device which received the enable signal fetches the display data addressed to itself and transmits the received enable signal to the previous display panel drive device. The foregoing operation is repeated, and the first display panel drive device which received the enable signal fetches the display data addressed to itself.

Accordingly, the forward-direction fetching operation mode and the reverse-direction fetching operation mode can be realized while a circuit configuration is simplified as much as possible. As a result, power reduction, cost reduction and downsizing of a panel frame can be realized when the bi-direction cascade transmission is realized.

In the panel display device thus constituted, the controller preferably outputs a shift switching signal for switching between the forward-direction fetching operation mode and the reverse-direction fetching operation mode to the respective display panel drive devices. Accordingly, the shift switching signal is supplied from the controller to the respective display panel drive devices so that it can be notified if the set operation is the forward-direction fetching operation mode or the reverse-direction fetching operation mode.

In the panel display device thus constituted, the controller preferably outputs a last device recognition signal showing if each of the display panel drive devices is the last display panel drive device which receives the display data, taking aim at each of the plurality of display panel drive devices. Accordingly, the last device recognition signal which is asserted is set in the last display panel drive device, whether the forward-direction fetching operation mode or the reverse-direction fetching operation mode, while the last device recognition signal which is negated is set in any display panel drive device other than the last display panel drive device. In the description of the present invention, the first device receives the data first, and the last device receives the data last.

In the panel display device thus constituted, the last device recognition signal is preferably set to “H” level or “L” level for each of the display panel drive devices. Accordingly, it becomes unnecessary to transmit the last device recognition signal from the controller.

In the panel display device thus constituted, the controller preferably outputs the last device recognition signal to the respective display panel drive devices. Accordingly, it becomes possible to freely switch between the forward-direction fetching operation mode and the reverse-direction fetching operation mode whenever necessary by adjusting the last device recognition signal outputted from the controller.

In the panel display device thus constituted, the controller preferably simultaneously transmits the display data of a plurality of channels as the display data and outputs a first device recognition signal showing if each of the display panel drive device is the first display panel drive device which receives the display data, taking aim at each of the plurality of display panel drive devices, and the display panel drive device in which the asserted first device recognition signal is set preferably transmits the received display data of the plurality of channels to the next display panel drive device in a timing different from one another. Accordingly, the display data of the plurality of channels can be transmitted in a timing different from one another, and the EMI (electromagnetic interference), the drop of a power-supply voltage and the like, which occur in the simultaneous transmission, can be controlled.

In the panel display device thus constituted, the first device recognition signal is preferably set to “H” level or “L” level by each of the display panel drive devices. Accordingly, it becomes unnecessary to transmit the first device recognition signal from the controller.

In the panel display device thus constituted, the controller preferably outputs the first device recognition signal to the respective display panel drive devices. Accordingly, it becomes possible to freely switch between the forward-direction fetching operation mode and the reverse-direction fetching operation mode whenever necessary by adjusting the first device recognition signal outputted from the controller.

In the panel display device thus constituted, each of the plurality of display panel drive devices preferably comprises a plurality of groups of display panel drive devices each cascade-connected to the display panel, wherein the plurality of groups of display panel drive devices can be independently operated. Accordingly, the plurality of groups of display panel drive devices can be independently operated.

As a result, such various settings as described below are can be realized:
the forward-direction fetching operation mode is set in all of the groups of display panel drive devices;
the reverse-direction fetching operation mode is set in all of the groups of display panel drive devices; and
the forward-direction fetching operation mode is set in some groups of display panel drive devices, and the reverse-direction fetching operation mode is set in the other groups of display panel drive devices.

In the panel display device thus constituted, the plurality of groups of display panel drive devices are preferably symmetrically placed with respect to the display panel. Accordingly, when the controller is routed with respect to the plurality of display panel drive devices, the routing can be simplified in any of the groups of display panel drive devices, which reduces the increase of a routing area.

In the panel display device thus constituted, the controller preferably outputs a shift switching signal for switching between the forward-direction fetching operation mode and the reverse-direction fetching operation mode, a last device recognition signal showing if each of the plurality of display panel drive devices is the last display panel drive device which receives the display data, taking aim at each of the plurality of display panel drive devices, and a transmission/reception switching signal to the respective display panel drive devices, and the plurality of groups of display panel drive devices preferably have a common constitution and are controlled by the shift switching signal, the last device recognition signal and the transmission/reception switching signal. Accordingly, the cost reduction can be further advanced since the display panel drive devices have a common constitution.

In the panel display device thus constituted, the plurality of display panel drive devices each preferably comprises:

a first transmitter/receiver for transmitting and receiving the various signals in the forward direction;

a second transmitter/receiver for transmitting and receiving the various signals in the reverse direction;

a shift register for generating a plurality of latch signals for fetching the display data; and

a latch circuit for fetching the display data based on the latch signals from the shift register, wherein

each of the plurality of display panel drive devices fetches the display data based on the latch signals for the first through last devices, makes the shift register operate based on the signals received by the first transmitter/receiver, and fetches the display data based on the latch signals for the last through first devices when the shift register generates the latch signals for the first through last devices based on the signals received by the first transmitters/receivers. The foregoing constitution can advantageously realize: the common structure is provided in the plurality of display panel drive devices; each of the plurality of groups of display panel drive devices is independently operated; the routing is simplified; and any increase of the circuit area is prevented.

In the panel display device thus constituted, the controller preferably outputs a transmission/reception switching signal for switching between transmission and reception as a role of each of the first and second transmitters/receivers, taking aim at each of the plurality of display panel drive devices. Accordingly, the forward-direction fetching operation mode and the reverse-direction fetching operation mode can be appropriately set.

In the panel display device thus constituted, the transmission/reception switching signal is preferably set to “H” level or “L” level for each of the display panel drive devices. Accordingly, it becomes unnecessary to transmit the transmission/reception switching signal from the controller.

In the panel display device thus constituted, the controller preferably outputs the transmission/reception switching signal to the respective display panel drive devices. Accordingly, it becomes possible to freely switch between the forward-direction fetching operation mode and the reverse-direction fetching operation mode whenever necessary by adjusting the transmission/reception switching signal outputted from the controller.

According to the present invention, in the panel display device comprising the display panel drive devices which are cascade-connected, the forward-direction fetching operation mode and the reverse-direction fetching operation mode can be realized while the circuit configuration can be maximally simplified. As a result, the power reduction, cost reduction and downsizing of the panel frame can be achieved when the bi-direction cascade transmission is realized.

The technology according to the present invention is advantageous in the power reduction, cost reduction and downsizing of the panel frame particularly when the bi-direction cascade transmission is realized in the panel display device in which the cascade connection is adopted such as a liquid crystal panel.

### BRIEF DESCRIPTION OF THE DRAWINGS

These and other objects of the invention will become clear by the following description of preferred embodiments of the invention and they will be specified in the claims attached hereto. A number of benefits not recited in this specification will come to the attention of the skilled in the art upon the implementation of the present invention.

FIG. 1 is a block diagram illustrating a constitution of a panel display device according to a preferred embodiment 1 of the present invention.

FIG. 2 is a timing chart illustrating the operation of a forward-direction fetching operation mode in the panel display device according to the preferred embodiment 1.

FIG. 3 is a timing chart illustrating the operation of a reverse-direction fetching operation mode in the panel display device according to the preferred embodiment 1.

FIG. 4 is a block diagram illustrating a constitution of a panel display device according to a preferred embodiment 2 of the present invention.

FIG. 5 is a timing chart of the panel display device according to the preferred embodiment 2.

FIG. 6 is a block diagram illustrating a constitution of a panel display device according to a preferred embodiment 3 of the present invention.

FIG. 7 is a block diagram illustrating a constitution of a panel display device according to a preferred embodiment 4 of the present invention.

FIG. 8 is a block diagram illustrating an exemplified constitution of a display panel drive device which is common to the preferred embodiments.

FIG. 9 shows a constitution of a shift register of the display panel drive device which is common to the preferred embodiments.

FIG. 10 shows a constitution of a first shift circuit in the shift register shown in FIG. 9.

FIG. 11 shows a constitution of a shift circuit other than the first and last shift circuits in the shift register shown in FIG. 9.

FIG. 12 shows a constitution of the last shift circuit in the shift register shown in FIG. 9.

FIG. 13 shows a constitution of a first control shift circuit in the shift register shown in FIG. 9.

FIG. 14 shows a constitution of a second control shift circuit in the shift register shown in FIG. 9.

FIG. 15 is a (first) timing chart illustrating the operation of display panel drive devices in a first group of display panel drive devices according to the preferred embodiment.

FIG. 16 is a (second) timing chart illustrating the operation of the display panel drive devices in the first group of display panel drive devices according to the preferred embodiment.

FIG. 17 is a (third) timing chart illustrating the operation of the display panel drive devices in the first group of display panel drive devices according to the preferred embodiment.

FIG. 18 is a (first) timing chart illustrating the operation of display panel drive devices in a second group of display panel drive devices according to the preferred embodiment.

FIG. 19 is a (second) timing chart illustrating the operations of the display panel drive devices in the second group of display panel drive devices according to the preferred embodiment.

FIG. 20 is a (third) timing chart illustrating the operations of the display panel drive devices in the second group of display panel drive devices according to the preferred embodiment.

FIG. 21 is a block diagram illustrating a constitution of a panel display device according to a conventional technology.

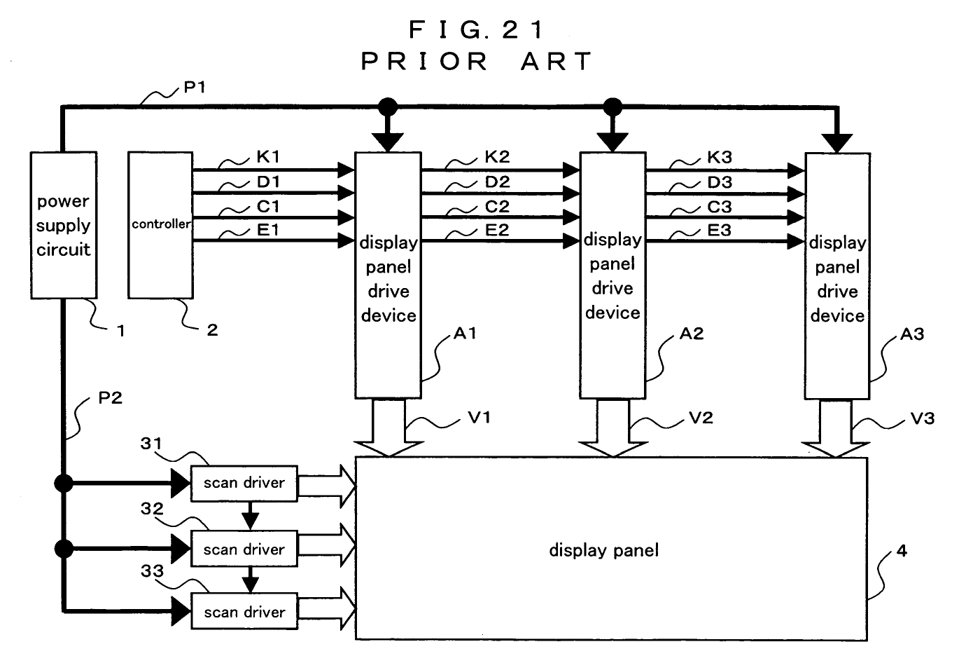

### DETAILED DESCRIPTION OF THE INVENTION

Hereinafter, preferred embodiments of a panel display device according to the present invention are described in detail referring to the drawings.

### Preferred Embodiment 1

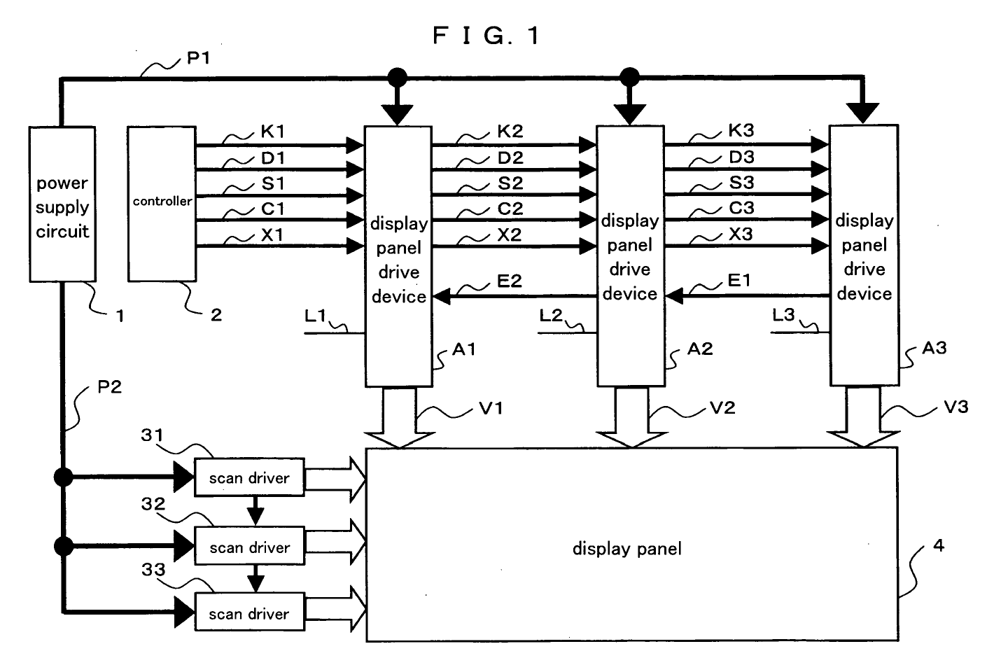

FIG. 1 is a block diagram illustrating a constitution of a panel display device according to a preferred embodiment 1 of the present invention. The panel display device according to the present preferred embodiment comprises a power supply circuit 1, a controller 2, display panel drive devices A1, A2 and A3 provided in three stages, three scan drivers 31, 32 and 33 provided in three stages, and a display panel 4.

A power supply P1 outputted from the power supply circuit 1 is applied to the display panel drive devices A1, A2 and A3. A power supply P2 is applied to the scan drivers 31, 32 and 33. A clock signal K1, display data D1, a start signal S1, a control signal C1 and a shift switching signal X1, all of which are outputted from the controller 2, are inputted to the first display panel drive device A1. A clock signal K2, display data D2, a start signal S2, a control signal C2 and a shift switching signal X2, all of which are outputted from the first display panel drive device A1, are inputted to the display panel drive device A2 in the cascade manner. A clock signal K3, display data D3, a start signal S3, a control signal C3 and a shift switching signal X3, all of which are outputted from the display panel drive device A2, are inputted to the last display panel drive device A3 in the cascade manner. An enable signal E1 transmitted from the last display panel drive device A3 is inputted to the display panel drive device A2. An enable signal E2 transmitted from the display panel drive device A2 is inputted in the cascade manner to the first display panel drive device A1. Last device recognition signals L1, L2 and L3 at fixed terminals are inputted to the display panel drive devices A1, A2 and A3, respectively. Gradation voltages V1, V2 and V3 outputted from the display panel drive devices A1, A2 and A3, respectively, are inputted to the display panel 4.

The shift switching signals X1, X2 and X3 are used to switch between an operation mode in which the display data is fetched in a forward direction from the first display panel drive device A1 to the last display panel drive device A3 and an operation mode in which the display data is fetched in a reverse direction from the last display panel drive device A3 to the first display panel drive device A1. These shift switching signals X1, X2 and X3 allow the cascade transmission in both directions. The forward-direction fetching operation mode is selected when the shift switching signals X1, X2 and X3 are set to “H” level, while the reverse-direction fetching operation mode is selected when the shift switching signals X1, X2 and X3 are set to “L” level.

The last device recognition signals L1, L2 and L3 are used for the confirmation of the last display panel drive device. Only the last device recognition signal L3 corresponding to the last display panel drive device A3 is set to “H” level, and the last device recognition signals L1 and L2 corresponding to the first display panel drive device A1 and the display panel drive device A2 are set to “L” level, in both of the forward-direction fetching operation mode and the reverse-direction fetching operation mode.

Next, the operation of the panel display device according to the present preferred embodiment thus constituted is described.

### 1) Forward-Direction Fetching Operation Mode

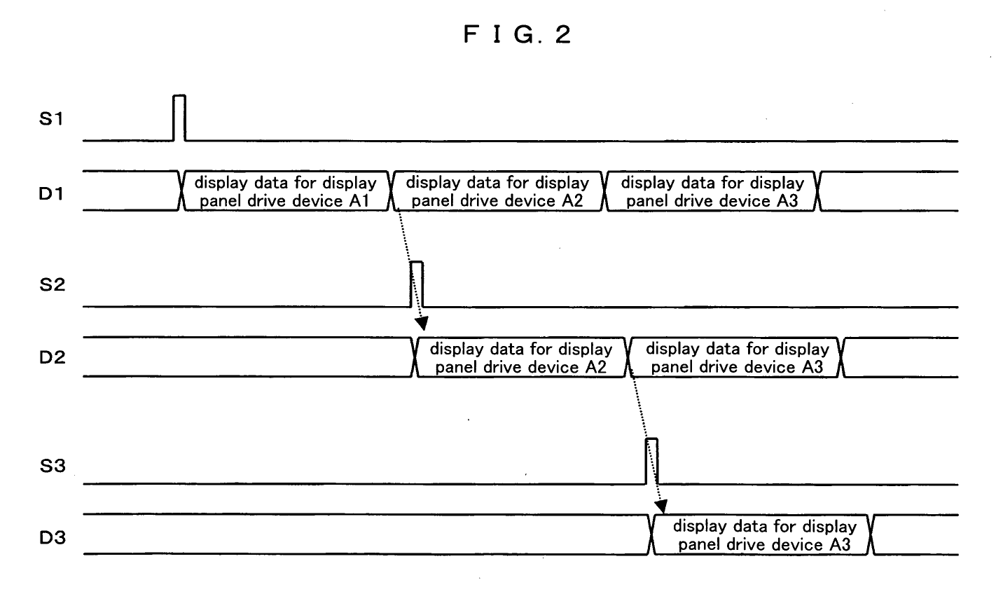

First, an operation in the forward-direction fetching operation mode is described referring to a timing chart shown in FIG. 2. When the shift switching signals X1, X2 and X3 are set to “H” level, the forward-direction fetching operation mode is set. At the time, only the last device recognition signal L3 corresponding to the last display panel drive device A3 is set to “H” level, and the last device recognition signals L1 and L2 corresponding to the other display panel drive devices A1 and A2 are set to “L” level.

The first display panel drive device A1 starts to fetch the display data corresponding thereto out of the display data D1 outputted from the controller 2 in synchronization with the clock signal K1 outputted from the controller 2 in response to the reception of the start signal S1 outputted from the controller 2. Before or after the fetch of the display data is completed, the first display panel drive device Al transmits the display data D2 and the start signal S2 to the display panel drive device A2 in synchronization with the clock signal K1.

The display panel drive device A2 starts to fetch the display data corresponding thereto out of the display data D2 transmitted from the first display panel drive device A1 in synchronization with the clock signal K2 transmitted from the first display panel drive device A1 in response to the reception of the start signal S2. Before or after the fetch of the display data is completed, the display panel drive device A2 transmits the display data D3 and the start signal S3 to the display panel drive device A3 in synchronization with the clock signal K2.

The last display panel drive device A3 starts to fetch the display data corresponding thereto out of the display data D3 transmitted from the display panel drive device A2 in synchronization with the clock signal K3 transmitted from the display panel drive device A2 in response to the reception of the start signal S3.

As described, the display data can be sequentially fetched in the forward direction from the first display panel drive device A1 to the last display panel drive device A3.

### 2) Reverse-Direction Fetching Operation Mode

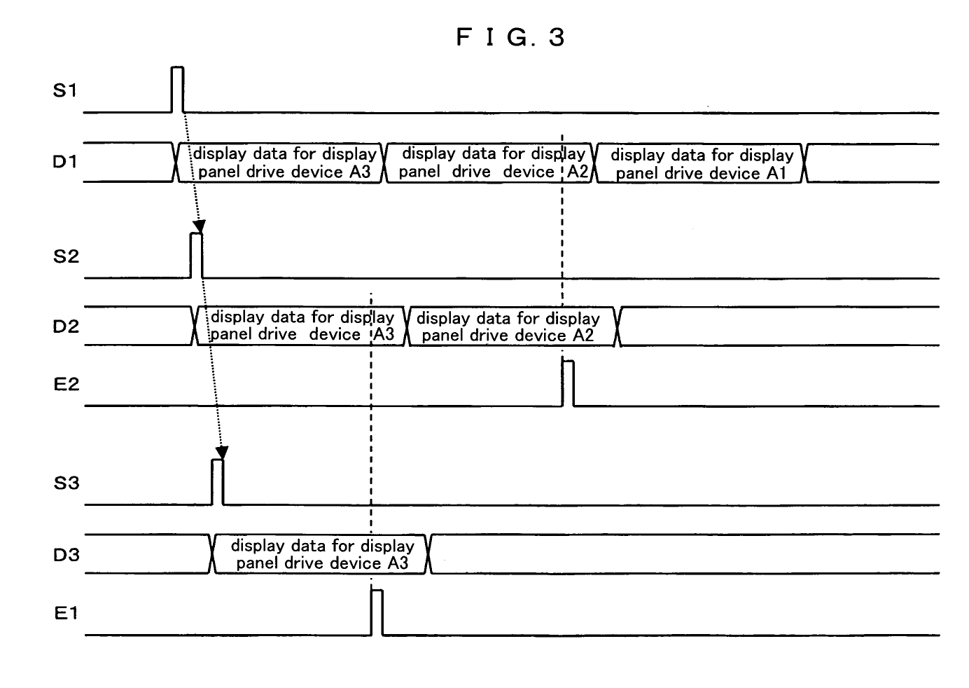

Next, the operation in the reverse-direction fetching operation mode is described referring to a timing chart shown in FIG. 3. When the shift switching signals X1, X2 and X3 are set to “L” level, the reverse-direction fetching operation mode is set. The last device recognition signal L1, L2 and L3 are set in a manner similar to 1).

Upon the reception of the start signal S1 outputted from the controller 2, the first display panel drive device A1 transmits the display data D2 and the start signal S2 to the display panel drive device A2 immediately after the reception in synchronization with the clock signal K1 outputted from the controller 2. At this stage, the first display panel drive device A1 does not fetch the display data addressed to itself.

Upon the reception of the start signal S2 outputted from the first display panel drive device A1, the display panel drive device A2 transmits the display data D3 and the start signal S3 to the last display panel drive device A3 immediately after the reception in synchronization with the clock signal K2 transmitted from the first display panel drive device A1. At this stage, the display panel drive device A2 does not fetch the display data addressed to itself.

Upon the reception of the start signal S3 outputted from the display panel drive device A2, the last display panel drive device A3 starts to fetch the display data corresponding thereto out of the display data D3 transmitted from the display panel drive device A2 in synchronization with the clock signal K3 transmitted from the display panel drive device A2. After that, the last display panel drive device A3 transmits the enable signal E1 to the display panel drive device A2 before the fetch of the display data is completed.

Upon the reception of the enable signal E1 transmitted from the last display panel drive device A3, the display panel drive device A2 starts to fetch the display data corresponding thereto out of the display data D2 transmitted from the first display panel drive device A1 in synchronization with the clock signal K2 transmitted from the first display panel drive device A1. After that, the display panel drive device A2 transmits the enable signal E2 to the first display panel drive device A1 before the fetch of the display data is completed.

Upon the reception of the enable signal E2 transmitted from the display panel drive device A2, the first display panel drive device A1 starts to fetch the display data corresponding thereto out of the display data D1 outputted from the controller 2 in synchronization with the clock signal K1 outputted from the controller 2.

As described, the display data can be sequentially fetched in the reverse direction from the last display panel drive device A3 to the first display panel drive device A1.

Since it is unnecessary for the display panel drive device which recognized itself as the last device through the last device recognition signal to transmit the data or the signal to the next device in either of the modes, the use of a function relating to the transmission is unnecessary, and a circuit section provided with the function relating to the transmission can be easily halted. As a result, power consumption can be reduced.

The last device recognition signals L1, L2 and L3 are fixedly set on the panel display device. As another possible method, pull-down elements or pull-up elements may be provided in the display panel drive devices in order to fixedly set the last device recognition signals L1, L2 and L3 to “H” level or “L” level so that the wirings required to fixedly set these signals can be reduced, or the last device recognition signals L1, L2 and L3, which are different from one another, may be supplied to the respective display panel drive devices from the controller 2 for the control operation in place of fixedly setting the last device recognition signals L1, L2 and L3 on the panel display device.

In the description, the display data is transmitted in synchronized with the start signal, the display data and the clock signal. The synchronization is unnecessary as far as timing margins such as a setup time or a hold time are sufficiently secured.

The power supply P1 from the power supply circuit 1 is not necessarily directly inputted to the display panel drive devices A1, A2 and A3. A signal transmission substrate or the like is generally used to route the power supply wirings. In order to reduce the wiring area, the power supply P1 may be cascade-transmitted from the first display panel drive device to the last display panel drive device in the same manner as the clock signal and the display data, which is also applied to the power supply P2. The present embodiment is applicable to the case where there are two or more display panel drive devices or the case where there is only one display panel drive device.

### Preferred Embodiment 2

In a preferred embodiment 2 of the present invention, the display data of a plurality of channels are used as the display data, and the EMI and the drop of the power-supply voltage, which are caused when the respective display data are simultaneously changed, can be controlled.

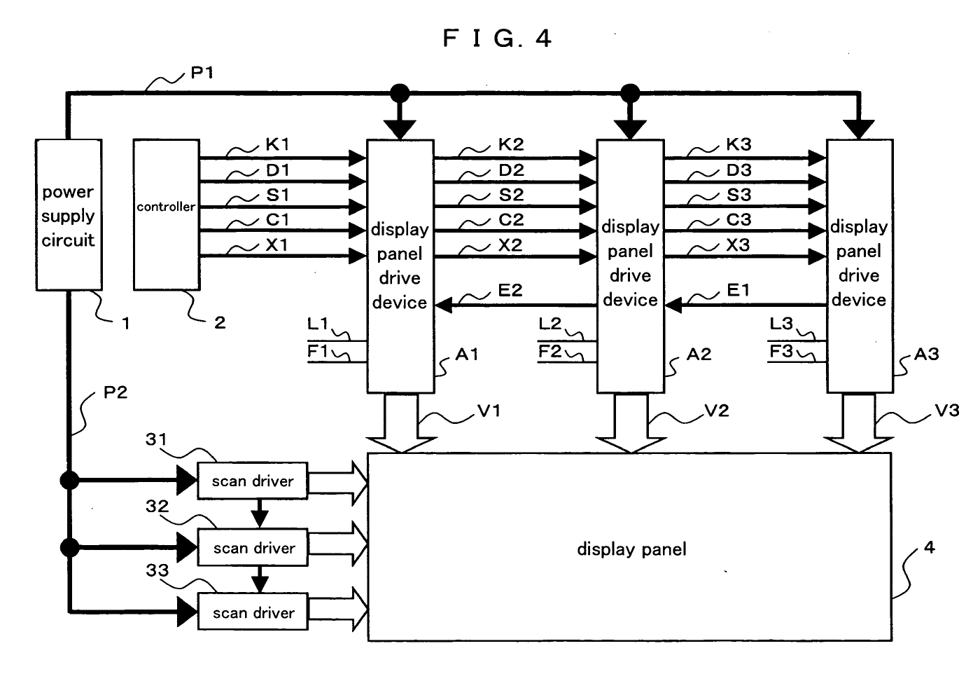

FIG. 4 is a block diagram illustrating a constitution of a panel display device according to the preferred embodiment 2. In FIG. 4, the same reference symbols as those shown in FIG. 1 according to the preferred embodiment 1 denote the same components. The constitution according to the present preferred embodiment is characterized in that first device recognition signals F1, F2 and F3 at fixed terminals are inputted to the display panel drive devices A1, A2 and A3, respectively. These first device recognition signals F1, F2 and F3 are used for the confirmation of the display panel drive device which first receives the display data. The first device recognition signal F1 corresponding to the first display panel drive device A1 is set to “H” level, and the first device recognition signals F2 and F3 corresponding to the other display panel drive devices A2 and A3 are set to “L” level in both of the forward-direction fetching operation mode and the reverse-direction fetching operation mode. The rest of the constitution, which is similar to that of the preferred embodiment 1, is not redundantly described.

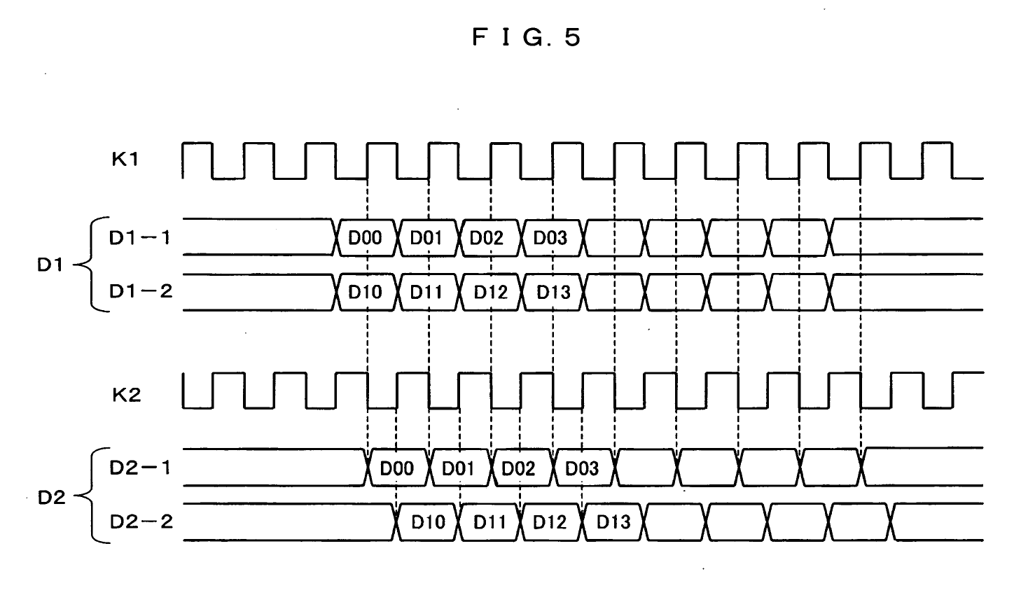

The operation of the panel display device according to the present preferred embodiment thus constituted is described. As shown in FIG. 5, there are two pieces of display data D1-1 and D1-2 as the display data D1, and there are two pieces of display data D2-1 and D2-2 as the display data D2. The first display drive device A1 in which the first device recognition signal F1 is set to “H” level fetches therein the display data D1-1 and D1-2 outputted from the controller 2 in synchronization with the rise of the clock signal K1. At the time of the transmission of the display data D1-1 and the display data D1-2 to the next display panel drive device A2, the first display drive device A1 transmits the display data D1-1 in synchronization with the rise of the clock signal K1, while transmitting the display data D1-2 in synchronization with the fall of the clock signal K1. Accordingly, the display data D1-2 can be transmitted with a half-cycle delay relative to the display data D1-1. The delay by the half cycle only in the first display panel drive device A1 is sufficient. By doing so, simultaneous change of data can be prevented. As a result, the EMI and the drop of the power-supply voltage, which are caused when the number of pieces of the data is increased and the numerous data are inevitably simultaneously changed, can be prevented.

The first device recognition signals F1, F2 and F3 may be fixedly set on the panel display device. Alternatively, pull-down elements or pull-up elements may be provided in the display panel drive devices A1, A2 and A3 in order to fixedly set the first device recognition signals F1, F2 and F3 to “H” level or “L” level so that the wirings required to fixedly set these signals can be reduced. Instead of fixing these signals, the first device recognition signals F1, F2 and F3 may be supplied from the controller 2 to the display panel drive devices A1, A2 and A3 for the control operation.

### Preferred Embodiment 3

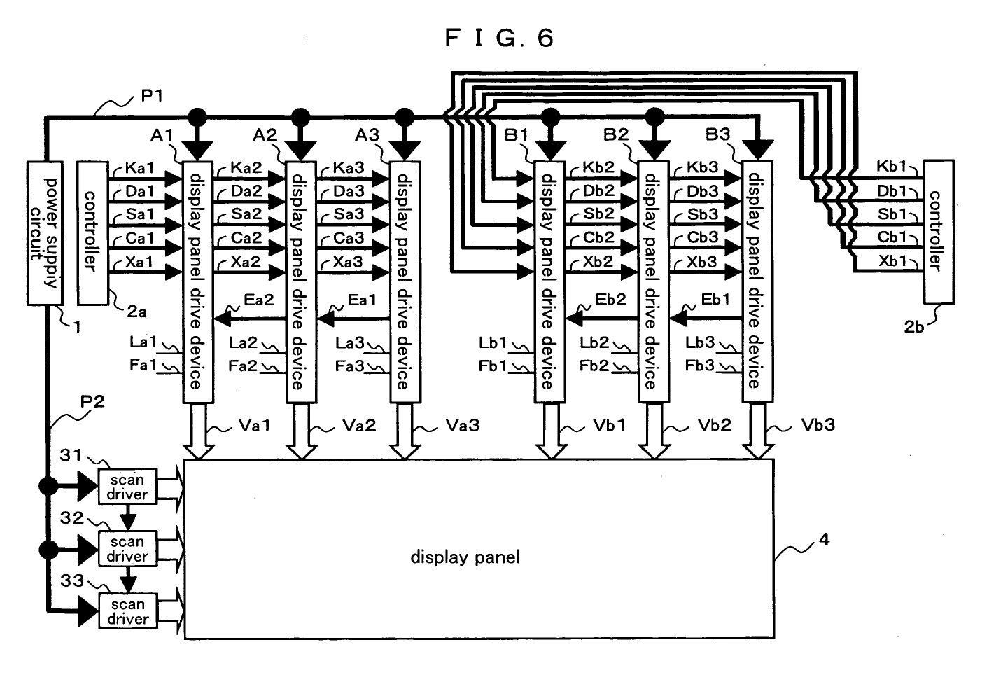

FIG. 6 is a block diagram illustrating a constitution of a panel display device according to a preferred embodiment 3 of the present invention. The constitution according to the present preferred embodiment is characterized in that another set of a controller 2 and display panel drive devices A1, A2 and A3 are provided in the preferred embodiment shown in FIG. 4. More specifically, a controller 2a and display panel drive device A1, A2 and A3 on the left side and a controller 2b and display panel drive device B1, B2 and B3 on the right side are provided. In order to distinguish the components on the right and left sides from each other, suffixes “a” and “b” are attached to the reference symbols and the various signals. Signal and data wirings from the controller 2b to the first display panel drive device B1 on the right side are largely detoured.

A clock signal Ka1, a display data Da1, a start signal Sa1, a control signal Ca1 and a shift switching signal Xa1, which are outputted from the controller 2a, are inputted to the first display panel drive device A1. A clock signal Ka2, a display data Da2, a start signal Sa2, a control signal Ca2 and a shift switching signal Xa2, which are transmitted from the first display panel drive device A1, are inputted to the display panel drive device A2. A clock signal Ka3, a display data Da3, a start signal Sa3, a control signal Ca3 and a shift switching signal Xa3, which are transmitted from the display panel drive device A2, are inputted to the last display panel drive device A3. An enable signal Ea1 transmitted from the last display panel drive device A3 is inputted to the display panel drive device A2. An enable signal Ea2 transmitted from the display panel drive device A2 is inputted to the first display panel drive device A1. Last device recognition signals La1-La3 at fixed terminals are inputted to the display panel drive devices A1, A2 and A3, respectively. First device recognition signals Fa1-Fa3 at fixed terminals are inputted to the display panel drive devices A1, A2 and A3, respectively. Gradation voltages Va1, Va2 and Va3 outputted from the display panel drive devices A1, A2 and A3 are inputted to a display panel 4.

A clock signal Kb1, a display data Db1, a start signal Sb1, a control signal Cb1 and a shift switching signal Xb1, which are outputted from the controller 2b, are inputted to the first display panel drive device B1. A clock signal Kb2, a display data Db2, a start signal Sb2, a control signal Cb2 and a shift switching signal Xb2, which are transmitted from the display panel drive device B1, are inputted to the display panel drive device B2. A clock signal Kb3, a display data Db3, a start signal Sb3, a control signal Cb3 and a shift switching signal Xb3, which are transmitted from the display panel drive device B2, are inputted to the last display panel drive device B3. An enable signal Eb1 transmitted from the last display panel drive device B3 is inputted to the display panel drive device B2. An enable signal Eb2 transmitted from the display panel drive device B2 is inputted to the first display panel drive device B1. Last device recognition signals Lb1-Lb3 at fixed terminals are inputted to the display panel drive devices B1, B2 and B3, respectively. First device recognition signals Fb1-Fb3 at fixed terminals are inputted to the display panel drive devices B1, B2 and B3, respectively. Gradation voltages Vb1, Vb2 and Vb3 outputted from the display panel drive devices B1, B2 and B3 are inputted to the display panel 4. From a power supply circuit 1 is supplied a power supply P1 to both of the display panel drive devices A1, A2 and A3 on the left side and the display panel drive devices B1, B2 and B3 on the right side.

According to the present preferred embodiment, the display panel drive devices A1, A2 and A3, which constitute a first group of display panel drive devices operated by the clock signal, the start signal etc. outputted from the controller 2a, and the display panel drive devices B1, B2 and B3, which constitute a second group of display panel drive devices operated by the clock signal, the start signal etc. outputted from the controller 2b, can be independently operated.

### Preferred Embodiment 4

In the preferred embodiment 3, the wirings which connect the controller 2b to the first display panel drive device B1 on the right side are routed in the roundabout and complicated manner, which may demand double-layer wirings in order to prevent the wirings from intersecting with one another or invite deterioration of cost performance due to an increased wiring area. A preferred embodiment 4 of the present invention solves the problems.

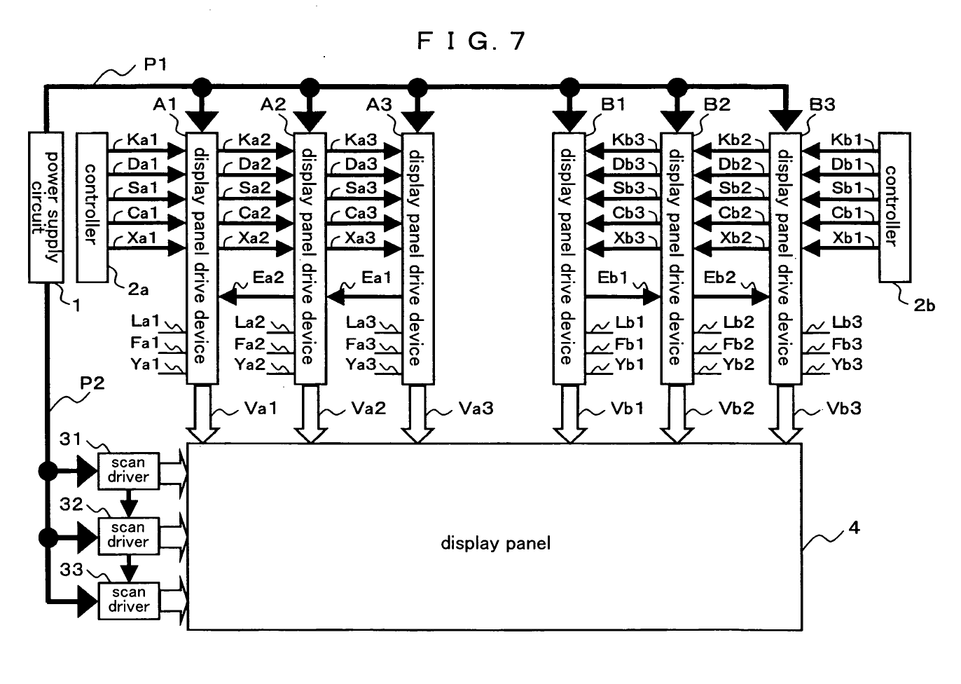

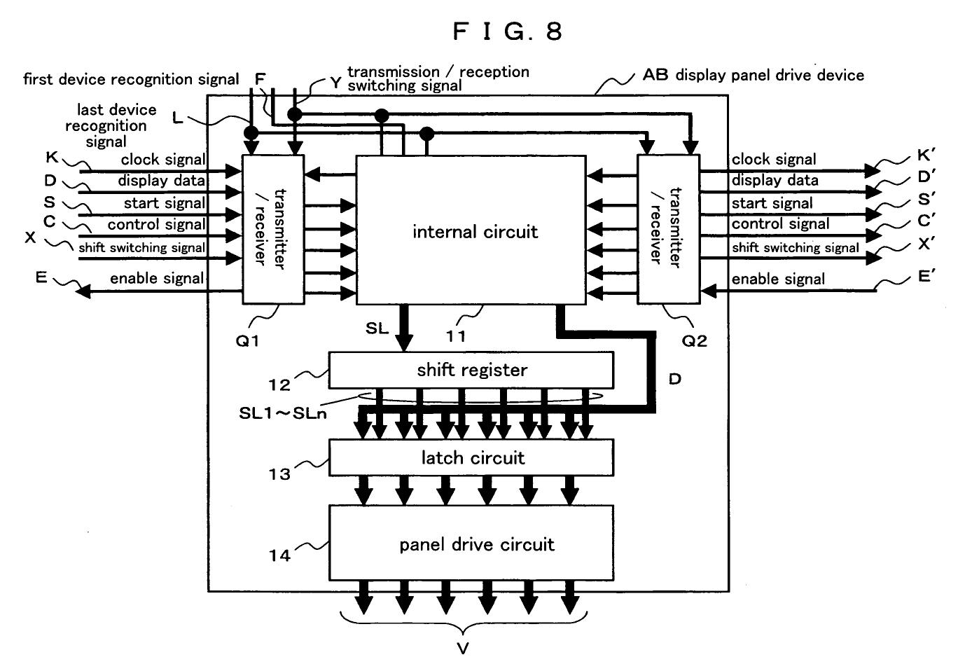

FIG. 7 is a block diagram illustrating a constitution of a panel display device according to the preferred embodiment 4. The same reference symbols as those shown in FIG. 6 according to the preferred embodiment 3 denote the same components. The constitution according to the present preferred embodiment is characterized in that any of the display panel drive devices comprises a first transmitter/receiver and a second transmitter/receiver capable of performing both transmission and reception (not shown, see FIG. 8). Transmission/reception switching signal Ya1, Ya2 and Ya3 at fixed terminals are inputted to the display panel drive devices A1, A2 and A3, respectively, and transmission/reception switching signal Yb1, Yb2 and Yb3 are inputted to the display panel drive devices B1, B2 and B3, respectively. These transmission/reception switching signals are signals for switching between transmission and reception as a role of the first transmitter/receiver and the second transmitter/receiver.

According to the present preferred embodiment, the signals outputted from the controller 2b can be inputted to one of the first transmitter/receiver and the second transmitter/receiver, whichever is closer, in the first display panel drive device B3 in the second group of display panel drive devices. As a result, the detoured wirings, which is an disadvantage in the preferred embodiment 3, can be avoided.

The transmission/reception switching signal Ya1, Ya2 and Ya3 and the transmission/reception switching signal Yb1, Yb2 and Yb3 may be fixedly set on the panel display device. Alternatively, pull-down elements or pull-up elements may be provided in the display panel drive devices in order to fixedly set the transmission/reception switching signal Ya1, Ya2 and Ya3 and the transmission/reception switching signal Yb1, Yb2 and Yb3 to “H” level or “L” level so that the wirings required to fixedly set these signals can be reduced. Instead of fixing these signals, these signals, which are different from one another, may be supplied from the controller 2 to the display panel drive devices for the control operation.

In the foregoing description, display panel drive devices configured in such a manner that the first group of display panel drive devices A1, A2 and A3 and the second group of display panel drive devices B1, B2 and B3 are combined are referred to as display panel drive devices AB.

An exemplified constitution of the display panel drive device AB is described referring to FIGS. 8 through 16. FIG. 8 is a block diagram illustrating a constitution of the display panel drive device AB. The display panel drive device AB comprises a first transmitter/receiver Q1, a second transmitter/receiver Q2, an internal circuit 11, a shift register 12, a latch circuit 13 and a panel drive circuit 14.

The first transmitter/receiver Q1 comprises a circuit for transmitting and receiving a clock signal K, a display data D, a start signal S, a control signal C, a shift switching signal X, and an enable signal E. In the first transmitter/receiver Q1, a circuit relating to the transmission to the next device is halted based on a last device recognition signal L as described earlier.

The second transmitter/receiver Q2 comprises a circuit for transmitting and receiving a clock signal K′, a display data D′, a start signal S′, a control signal C′, a shift switching signal X′, and an enable signal E′. In the second transmitter/receiver Q2, a circuit relating to the transmission to the next device is halted based on the last device recognition signal L as described earlier.

In the first transmitter/receiver Q1 and the second transmitter/receiver Q2, the control method is changed in the first display panel drive device AB and any display panel drive device AB thereafter when the display data inputted to the first display panel drive device AB by the first device recognition signal F and the display data transmitted to any display panel drive device AB thereafter have different timings. Further, in the first transmitter/receiver Q1 and the second transmitter/receiver Q2, the control is exerted to switch between the transmission and the reception based on a transmission/reception switching signal Y.

The internal circuit 11 selects if the signals of the first transmitter/receiver Q1 are used or the signals of the second transmitter/receiver Q2 are used, and generates various internal signals necessary for controlling the display panel drive device AB, such as a reset signal and an internal clock signal, based on the selected signals, and transfers the generated necessary signals to each block. The internal circuit 11 further synchronizes the display data received by the first transmitter/receiver Q1 or the display data received by the second transmitter/receiver Q2.

The latch circuit 13 is a circuit for fetching a display data D outputted from the internal circuit 11 by a latch signal SL outputted from the shift register 12. The panel drive circuit 14 is a circuit for outputting a gradation voltage V using the display data D outputted from the latch circuit 13.

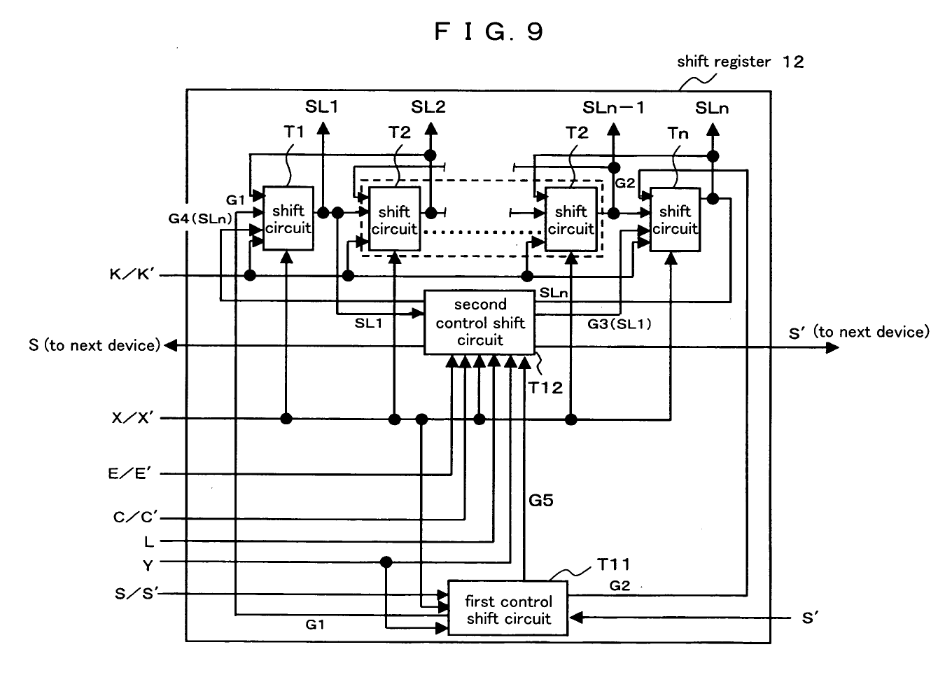

As shown in FIG. 9, the shift register 12 comprises a first shift circuit T1, shift circuits T2, being shift circuits other than the first and a last shift circuits, the last shift circuit Tn, a first control shift circuit T11 and a second control shift circuit T12.

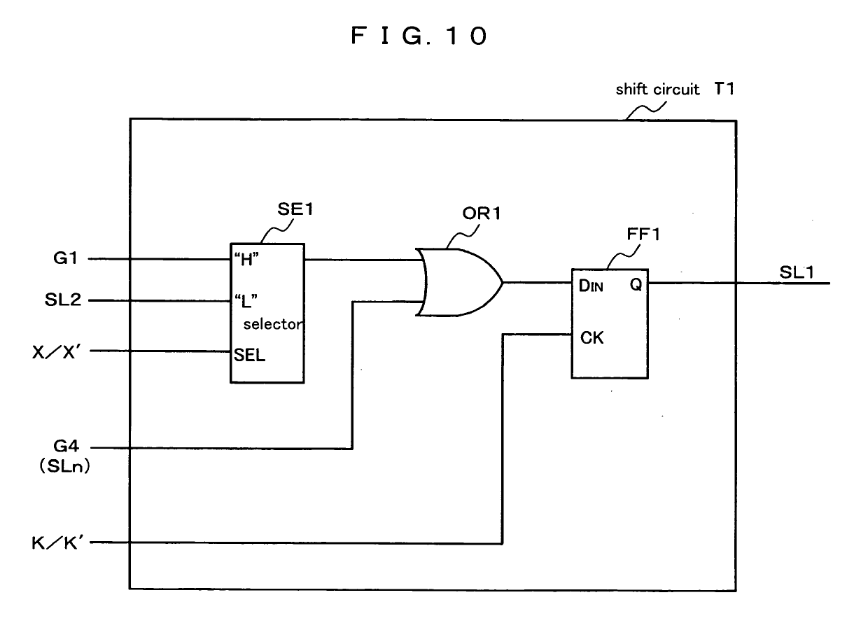

As shown in FIG. 10, the first shift circuit T1 comprises a selector SE1 for selecting one of an AND signal G1 outputted from the first control shift circuit T11 and a latch signal SL2 of the next shift circuit T2 using a shift switching signal X or a shift switching signal X′, an OR gate OR1 for calculating a logical sum of the signal outputted from the selector SE1 and an AND signal G4 (derived from latch signal SLn) outputted from the second control shift circuit T12, and a flip-flop FF1 for fetching the signal outputted from the OR gate OR1 using the clock signal K or the clock signal K′. The flip-flop FF1 outputs a latch signal SL1. The latch signal SL1 is supplied to the latch circuit 13, the next shift circuit T2 and the second control shift circuit T12.

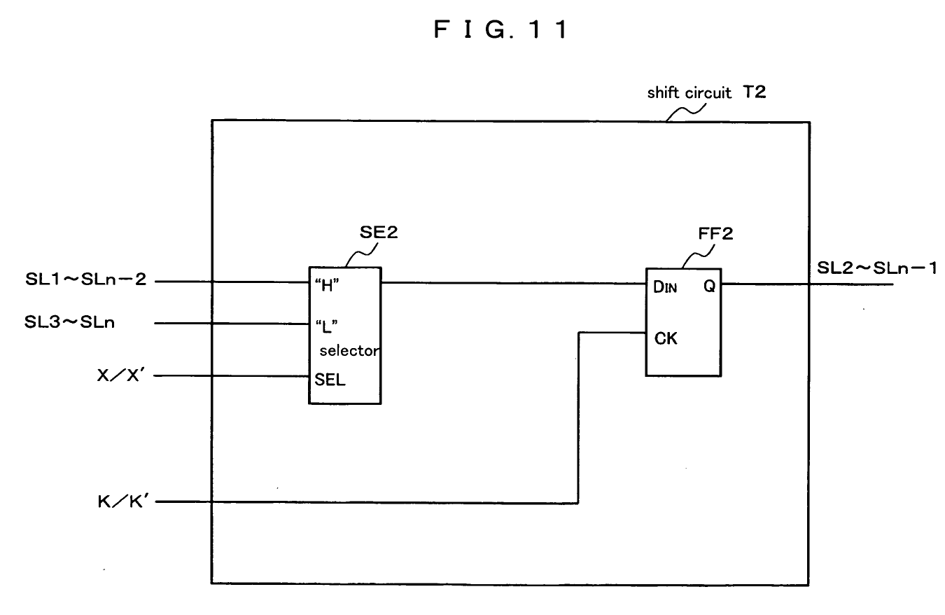

As shown in FIG. 11, the shift circuit T2 comprises a selector SE2 for selecting the latch signals SL1-SLn-2 of the previous shift circuits T1 and T2 or the latch signals SL3-SLn of the next shift circuit T2 using the shift switching signal X or the shift switching signal X′, and a flip-flop FF2 for fetching the signal outputted from the selector SE2 using the clock signal K or the clock signal K′. The flip-flop FF2 outputs the latch signal SL2-SLn-1. Circuits that output the latch signals SL2-SLn-1 are all deemed to be the shift circuit T2.

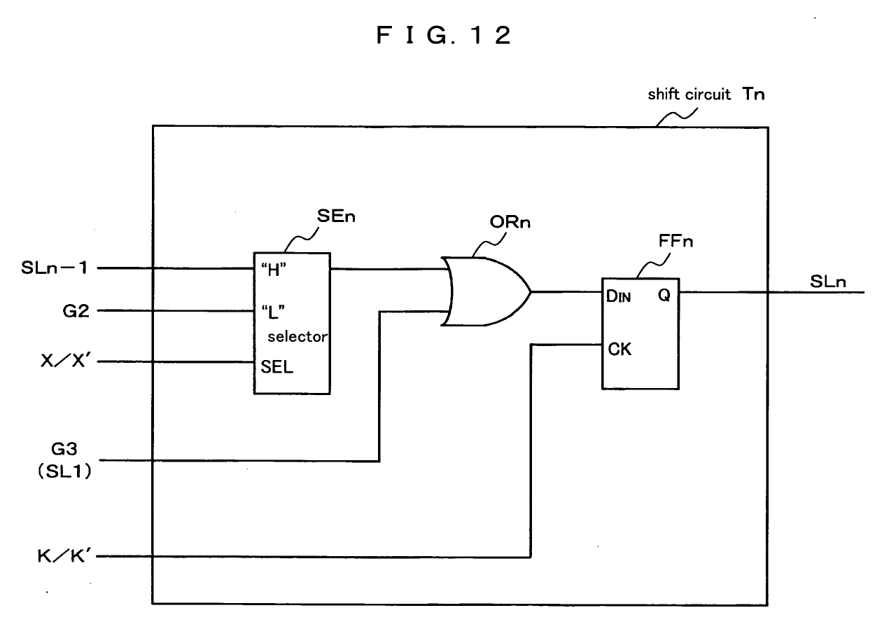

As shown in FIG. 12, the last shift circuit Tn comprises a selector SEn for selecting one of the latch signal SLn-1 of the previous shift circuit Tn-1 (shift circuit T2) and the AND signal G2 outputted from the first control shift circuit T11 using the shift switching signal X or the shift switching signal X′, an OR gate ORn for calculating a logical sum of the signal outputted from the selector SEn and the AND signal G3 (derived from latch signal SL1) outputted from the second control shift circuit T12, and a flip-flop FFn for fetching the signal outputted from the OR gate ORn using the clock signal K or the clock signal K′. The flip-flop FFn outputs the latch signal SLn. The latch signal SLn is supplied to the latch circuit 13 and the second control shift circuit T12.

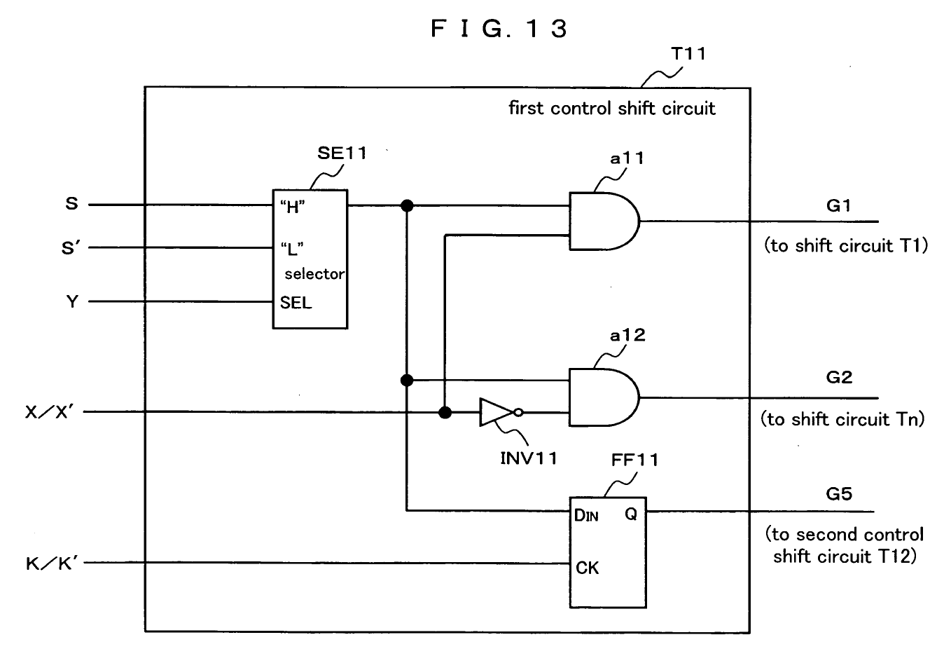

As shown in FIG. 13, the first control shift circuit T11 comprises a selector SE11 for selecting one of the start signal S and the start signal S′ using the transmission/reception switching signal Y, an AND gate all for calculating a logical product of the output signal of the selector SE11 and the shift switching signal X or the shift switching signal X′ and outputting the AND signal G1 to the first shift circuit T1, an inverter INV11 for generating an inversion signal of the shift switching signal X or the shift switching signal X′, an AND gate a12 for calculating a logical product of the output signal of the inverter INV11 and the output signal of the selector SE11 and outputting the AND signal G2 to the last shift circuit Tn, and a flip-flop FF11 for fetching the output signal of the selector SE11 using the clock signal K or the clock signal K′. The flip-flop FF11 outputs the signal G5 to the second control shift circuit T12.

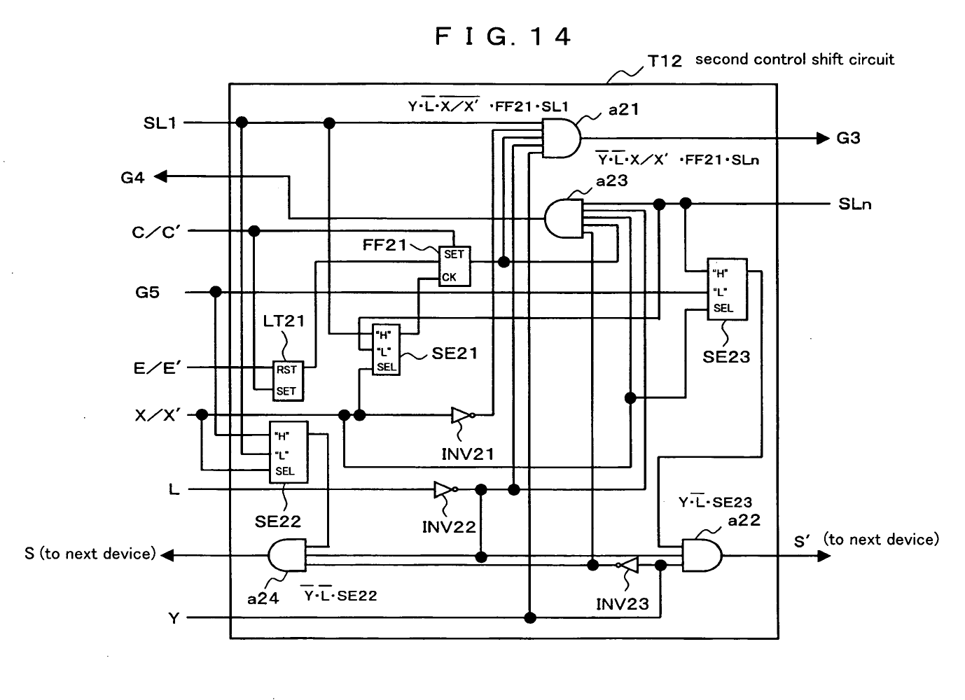

As shown in FIG. 14, the second control shift circuit T12 comprises an RS latch LT21 which is set to “L” level based on the enable signal E or the enable signal E′ and set to “H” level based on the control signal C or the control signal C′, a selector SE21 for selecting one of the latch signal SL1 from the first shift circuit T1 and the latch signal SLn from the last shift circuit Tn based on the shift switching signal X or the shift switching signal X′, a flip-flop FF21 which is set to “H” level by the control signal C or the control signal C′ and fetches the signal outputted from the RS latch LT21 based on the timing signal outputted from the selector SE21, an inverter INV21 for generating an inversion signal of the shift switching signal X or the shift switching signal X′, and inverter INV22 for generating an inversion signal of the last device recognition signal L, an inverter INV 23 for generating an inversion signal of the transmission/reception switching signal Y, a selector SE22 for selecting one of the signal G5 from the first control shift circuit T11 and the latch signal SL1 from the first shift circuit T1 based on the shift switching signal X or the shift switching signal X′, a selector SE23 for selecting one of the signal G5 outputted from the first control shift circuit T11 and the latch signal SLn from the last shift circuit Tn based on the shift switching signal X or the shift switching signal X′, and AND gates a21, a22, a23 and a24. The AND gate a21 calculates a logical product of the transmission/reception switching signal Y, the inversion signal of the last device recognition signal L from the inverter INV 22, the inversion signal of the shift switching signal X or the shift switching signal X′ from the inverter INV21, the delayed enable signal E or enable signal E′ outputted from the flip-flop FF21, and the latch signal SL1, and outputs the AND signal G3 to the last shift circuit Tn. The AND gate a23 calculates a logical product of the inversion signal of the transmission/reception switching signal Y from the inverter INV23, the inversion signal of the last device recognition signal L from the inverter INV 22, the shift switching signal X or the shift switching signal X′, the delayed enable signal E or enable signal E′ outputted from the flip-flop FF21, and the latch signal SLn, and outputs the AND signal G4 to the first shift circuit T1. The AND gate a22 calculates a logical product of the transmission/reception switching signal Y, the inversion signal of the last device recognition signal L from the inverter INV 22, and the output signal of the selector SE23, and outputs the start signal S′ corresponding to the next device as a result of the calculation. The AND gate a24 calculates a logical product of the inversion signal of the transmission/reception switching signal Y from the inverter INV23, the inversion signal of the last device recognition signal L from the inverter INV 22, and the output signal of the selector SE22, and outputs the start signal S corresponding to the next device as a result of the calculation.

Next, the operation of the panel display device according to the present preferred embodiment thus constituted is described.

a) Display Panel Drive Devices A1, A2 and A3 of First Group of Display Panel Drive Devices

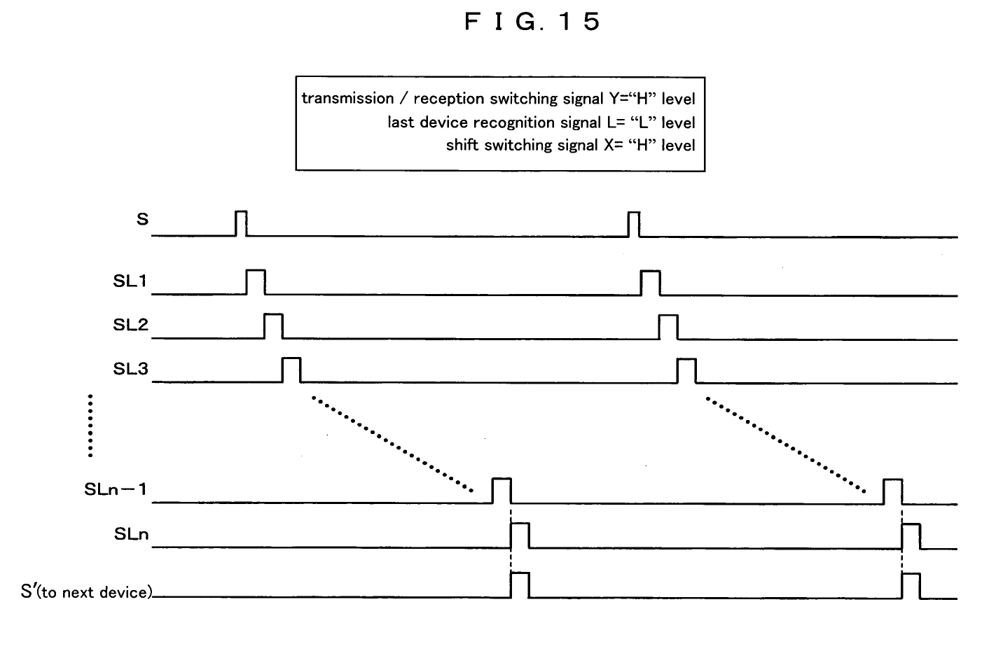

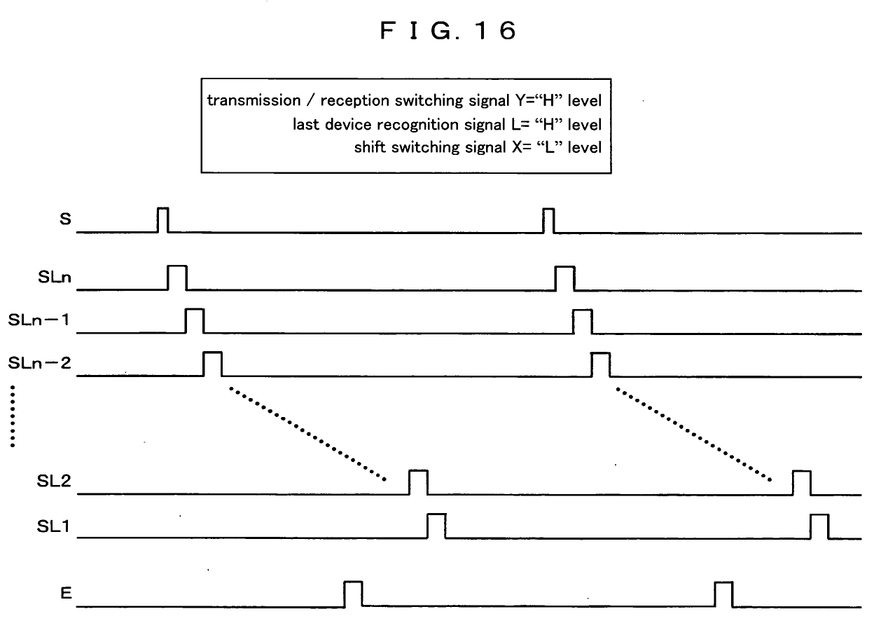

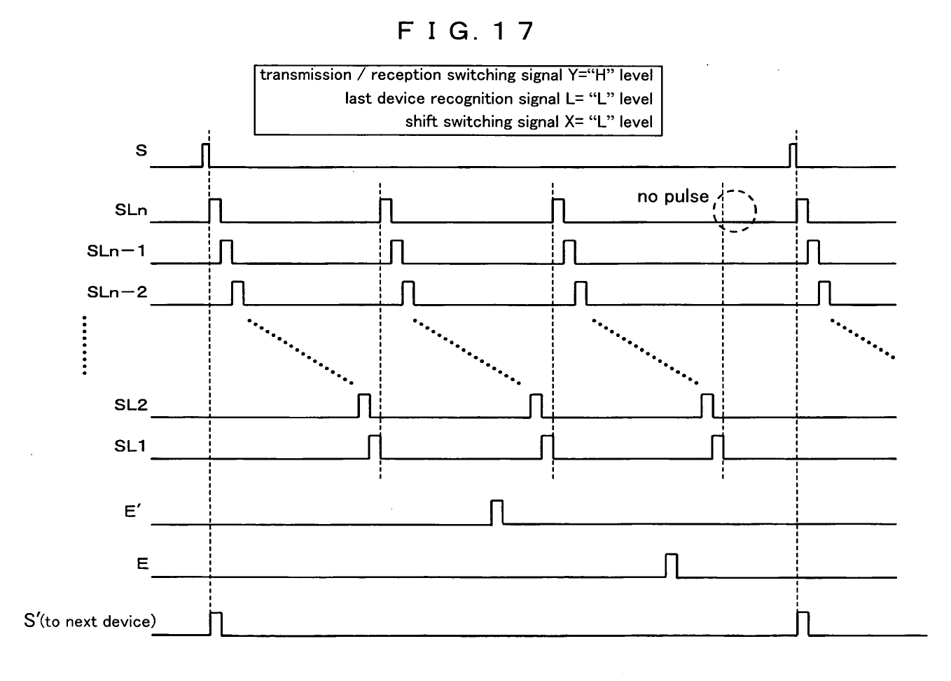

FIGS. 15, 16 and 17 are timing charts relating to the operation of the display panel drive devices A1, A2 and A3 of the first group of display panel drive devices. FIG. 15 is a timing chart of the forward-direction fetching operation mode in the display panel drive devices A1 and A2, other than the last display panel drive device. FIG. 16 is a timing chart of the reverse-direction fetching operation mode in the last display panel drive device A3. FIG. 17 is a timing chart of the reverse-direction fetching operation mode in the display panel drive devices A1 and A2, other than the last display panel drive device. In FIGS. 15-17, the transmission/reception switching signal Y is set to “H” level, and the selector SE11 thereby selects the start signal S from an “H” selection input terminal in the first control shift circuit T11 shown in FIG. 13. The second control shift circuit T12 shown in FIG. 14 sets the AND gates a23 and a24 to the OFF state.

1) Forward-Direction Fetching Operation Mode

FIG. 15 is a timing chart illustrating the operations of the display panel drive devices A1 and A2, other than the last display panel drive device, in the forward-direction fetching operation mode. In this case, the transmission/reception switching signal Y is set to “H” level, the last device recognition signal L is set to “L” level, and the shift switching signal X is set to “H” level.

Since the last device recognition signal L is set to “L” level, the display panel drive devise A1 and A2, other than the last display panel drive device, are operated. Further, the AND gate all is in the ON state and the AND gate a12 is in the OFF state in the first control shift circuit T11 shown in FIG. 13 since the shift switching signal X is set to “H” level. As a result, the first control shift circuit T11 transmits the AND signal G1 to the first shift circuit T1, in other words, the start signal S is transmitted in the forward direction, which is the forward-direction fetching operation mode. Further, in the second control shift circuit T12 shown in FIG. 14, the AND gate a21 is in the OFF state since the shift switching signal X is at “H” level. The AND gate a22 is in the ON state since the last device recognition signal L and the transmission/reception switching signal Y are at “L” level. The AND gate a23 is in the OFF state since the transmission/reception switching signal Y is at “H” level. The AND gate a24 is in the OFF state since the transmission/reception switching signal Y is at “H” level. Therefore, only the AND a22 is in the ON state.

In the first control shift circuit T11 shown in FIG. 13, the selector SE11 selects the start signal S from the controller 2, and the AND gate all transmits the AND signal G1 to the first shift circuit T1. In the first shift circuit T1 shown in FIG. 10, the selector SE1 selects the AND signal G1 from the first control shift circuit T11 since the shift switching signal X is at “H” level. The selected signal is inputted to the flip-flop FF1 via the OR gate OR1. The other input of the OR gate OR1 is the output G4 of the AND gate a23. The other input is at “L” level since the AND gate a23 is in the OFF state as described. In the flip-flop FF1, the AND signal G1 is fetched in synchronization with the clock signal K and inputted to the latch circuit 13 as the latch signal SL1 and to an “H” selection input terminal of the selector SE2 in the next shift circuit T2 shown in FIG. 11. The AND signal G1 is also inputted to the AND gate a21 in the second control shift circuit T12 shown in FIG. 14; however, the AND signal G1 is irrelevant to the AND gate a21. Because the shift switching signal X is at “H” level in the shift circuit T2, the selector SE2 selects the latch signal SL1 transmitted from the first shift circuit T1, and the selected latch signal SL1 is inputted to the flip-flop FF2. In the flip-flop FF2, the latch signal SL1 is fetched in synchronization with the clock signal K and inputted to an “H” selection input terminal of the selector SE2 in the next shift circuit T2. Thereafter, the latch signal is transmitted via the shift circuit T2 and finally inputted to an “H” selection input terminal of the selector SEn in the last shift circuit Tn shown in FIG. 12. Because the shift switching signal X is at “H” level in the last shift circuit Tn shown in FIG. 12, the selector SEn selects the latch signal SLn-1 from the previous shift circuit Tn-1. The latch signal SLn-1 is inputted to the flip-flop FFn via the OR gate ORn. The other input of the OR gate ORn is the output G3 of the AND gate a21 in the second control shift circuit T12. However, as described earlier, the other input of the OR gate ORn and the output G3 of the AND gate a21 in the second control shift circuit T12 are irrelevant to each other since the AND gate a21 is in the OFF state. In the flip-flop FFn, the latch signal SLn-1 is fetched in synchronization with the clock signal K. The latch signal SLn-1 is supplied to the latch circuit 13 as the latch signal SLn and the AND gate a23 and the selector SE23 in the second control shift circuit T12 shown in FIG. 14. Further, the latch signal SLn is selected because the shift switching signal X at “H” level is supplied in the selector SE23, and the selected latch signal SLn is supplied to the AND gate a22. Because the AND gate a22 is in the ON state as described earlier, the latch signal SLn is outputted as the start signal S′ with respect to the next display panel drive device. At the time, the start signal S′ is irrelevant to the AND gate a23 and the selector SE21.

The latch signal SL1 is transmitted from the first shift circuit T1 to the latch circuit 13, the latch signals SL2, . . . SLn-1 are transmitted from the respective shift circuits T2 to the latch circuit 13, and the latch signal SLn is transmitted from the last shift circuit Tn to the latch circuit 13.

As described, the latch signals SL1-SLn in the forward direction are generated in order to fetch the display data D into the latch circuit 13 after the start signal S is received. In this case, the operation of the shift register 12 is temporarily halted after the latch signal SLn is outputted, and the shift register 12 is not operated until the next start signal S is inputted. The second transmitter/receiver Q2 transmits the latch signal SLn as the start signal with respect to the next device. The latch circuit 13 fetches the display data outputted from the internal circuit 11 using the latch signals SL1-SLn outputted from the shift register 12. Then, the panel drive circuit 14 generates the gradation voltage V based on the display data D outputted from the latch circuit 13 and outputs the generated voltage to the display panel 4.

Though a timing chart is omitted, when the last device recognition signal L is at “H” level, the last display panel drive device A3 is operated in a manner different to the foregoing description. In the second control shift circuit T12 shown in FIG. 14, the output of the inverter INV 22 is at “L” level since the last device recognition signal L is at “H” level, and the AND gate a22 is in the OFF state. As a result, the latch signal SLn is not transmitted from the second transmitter/receiver Q2 as the start signal S′ with respect to the next device. The rest of the operation is similar to the operation described earlier.

2) Reverse-Direction Fetching Operation Mode

FIG. 16 is a timing chart illustrating the operation of the last display panel drive device A3 in the reverse-direction fetching operation mode. The transmission/reception switching signal Y is set to “H” level, the last device recognition signal L is set to “H” level, and the shift switching signal X is set to “L” level. In comparison to FIG. 15, the last device recognition signal L and the shift switching signal X show the opposite logic, while the transmission/reception switching signal Y shows the same logic.

Because the last device recognition signal L is set to “H” level, the last display panel drive device A3 is operated. Further, because the shift switching signal X is set to “L” level, the AND gate all is in the OFF state, and the AND gate a12 is in the ON state in the first control shift circuit T11 shown in FIG. 13. As a result, the first control shift circuit T11 transmits the AND signal G2 to the last shift circuit Tn. The start signal S is thereby transmitted in the reverse direction, which is the reverse-direction fetching operation mode. In the second control shift circuit T12 shown in FIG. 14, the AND gates a21, a22, a23 and a24 are in the OFF state because the last device recognition signal L is at “H” level. As a result, the second control shift circuit T12 is not operated.

In the first control shift circuit T11 shown in FIG. 13, the selector SE11 selects the start signal S from the controller 2, and the AND gate a12 transmits the AND signal G2 to the last shift circuit Tn. In the last shift circuit Tn shown in FIG. 12, the selector SEn selects the AND signal G2 from the first control shift circuit T11 because the shift switching signal X is at “L” level. The selected signal is supplied to the flip-flop FFn via the OR gate ORn. Though the output G3 of the AND gate a21 is supplied to the other input of the OR gate ORn, the OR gate ORn is at “L” level because the AND gate a21 is in the OFF state as described earlier. The AND signal G2 is fetched into the flip-flop FFn in synchronization with the clock signal K, and the AND signal G2 is supplied to the latch circuit 13 as the latch signal SLn and an “L” selection input terminal of the selector SE2 in the next shift circuit T2 shown in FIG. 11. The AND signal G2 is also inputted to the AND gate a23 and the selector SE23 in the second control shift circuit T12 shown in FIG. 14; however, the AND signal G2 is irrelevant to the AND gate a23 and the selector SE23.

Because the shift switching signal X is at “L” level in the previous shift circuit T2 shown in FIG. 11, the selector SE2 selects the latch signal SLn transmitted from the last shift circuit Tn, and the selected latch signal SLn is supplied to the flip-flop FF2. The latch signal SLn is fetched into the flip-flop FF2 in synchronization with the clock signal K, and supplied to an “L” selection input terminal of the selector SE2 in the previous shift circuit T2 as the latch signal SLn-1. Thereafter, the latch signal SLn-1 is transmitted via the shift circuit T2, and finally supplied as the latch signal SL2 to an “L” selection input terminal of the selector SE1 in the first shift circuit T1 shown in FIG. 10. In the first shift circuit T1, the shift switching signal X is at “L” level, and therefore, the selector SE1 selects the latch signal SL2. The selected latch signal SL2 is supplied to the flip-flop FF1 via the OR gate OR1. The output G4 of the AND gate a23 is supplied to the other input of the OR gate OR1; however, the output G4 is irrelevant to the OR gate OR1 because the AND gate a23 is in the OFF state as described. The latch signal SL2 is fetched into flip-flop FF1 in synchronization with the clock signal K and outputted to the latch circuit 13 as the latch signal SL1. The latch signal SL1 is also inputted to the selector SE21 and the AND gate a21 in the second control shift circuit T12 shown in FIG. 14; however, the latch signal SL1 is irrelevant to the selector SE21 and the AND gate a21.

FIG. 17 is a timing chart illustrating the operations of the display panel drive devices A1 and A2, other than the last display panel drive device, in the reverse-direction fetching operation mode. In this case, the transmission/reception switching signal Y is set to “H” level, the last device recognition signal L is set to “L” level, and the shift switching signal X is set to “L” level. In the first control shift circuit T11 shown in FIG. 13, the transmission/reception switching signal Y is at “H” level, and the selector SE11 accordingly selects the start signal S. Because the AND gate all is in the OFF state and the AND gate a12 is in the ON state, the first control shift circuit T11 supplies the start signal S to an “L” selection input terminal of the selector SEn in the last shift circuit Tn as the AND signal G2. In the second control shift circuit T12 shown in FIG. 14, the AND gates a21 and a22 are in the ON state, while the AND gates a23 and a24 are in the OFF state.

After the reception of the start signal S (AND signal G2), the last shift circuit Tn outputs the latch signals SLn-SL1 in the reverse direction. However, in the second control shift circuit T12 shown in FIG. 14, an RS latch LT 21 continues to output “H” level to a data input terminal of the flip-flop FF21 unless the enable signal E′ is inputted to the RS latch LT21. Therefore, the input supplied from the flip-flop FF21 to the AND gate a21 is “H” level. When the latch signal SL1 is inputted from the first shift circuit T1 to the AND gate a21 in the ON state, the AND signal G3 is supplied to the OR gate ORn of the last shift circuit Tn as another start signal. Therefore, the AND signal G3 (another start signal) is outputted again to the last shift circuit Tn as the latch signal SLn, and the foregoing operation is thereby repeated. Accordingly, the second control shift circuit T12 repeatedly outputs the latch signals SLn-SL1 until the enable signal E′ is inputted to the RS latch LT 21.

When the enable signal E′ is generated by the second transmitter/receiver Q2 and supplied to the RS latch LT21 in the second control shift circuit T12 shown in FIG. 14 in the foregoing process, the RS latch LT21 is reset and outputs “L” level to the data input terminal of the flip-flop FF21. Next, when the last shift circuit Tn outputs the latch signal SLn, the outputted latch signal SLn is supplied to the “L” selection input terminal of the selector SE21 in the second control shift circuit T12. Then, the output of the selector SE21 triggers the flip-flop FF21, and the output of the flip-flop FF21 turns to be at “L” level, which inverts the AND gate a21 to the OFF state. Therefore, the AND gate a21 does not output the AND signal G3 though the latch signal SL1 is inputted to the AND gate a21 from the first shift circuit T1. As a result, the latch signals SLn-SL1 are not anymore repeatedly outputted.

The shift register 12 generates the next latch signals SLn-SL1 by which the enable signal E′ is inputted as the latch signals SLn-SL1 for fetching the display data D for itself. Then, the shift register 12 temporarily halts its operation and is not operated until the next start signal is inputted. The first transmitter/receiver Q1 transmits a latch signal earlier by a few signals than the latch signal SL1 that follows the next latch signal SLn (the enable signal E′ is inputted at the timing of this signal) as the enable signal E.

Because the AND gate a22 is in the ON state, the second transmitter/receiver Q2 transmits the signal G5 outputted from the first control shift circuit T11 as the start signal S′ with respect to the next device.

As so far described, the shift register 12 generates the latch signals SLn-SL1 in the reverse direction for fetching the display data D into the latch circuit 13 after the reception of the start signal S. Further, the shift register 12 outputs the latch signals SLn-SL1 again until the enable signal E′ is inputted, and generates the next latch signals SLn-SL1 by which the enable signal E′ is inputted as the latch signals for fetching the display data for itself. After that, the shift register 12 temporarily halts its operation and is not operated until the next start signal is inputted. Further, the first transmitter/receiver Q1 transmits a latch signal earlier by a few signals than the latch signal SL1 that follows the next latch signal SLn (the enable signal E′ is inputted at the timing of this signal) as the enable signal E. Further, the second transmitter/receiver Q2 transmits the signal G5 outputted from the first control shift circuit T11 as the start signal S′ with respect to the next device.

b) Operation of Display Panel Drive Devices B1, B2 and B3 in Second Group of Display Panel Drive Devices

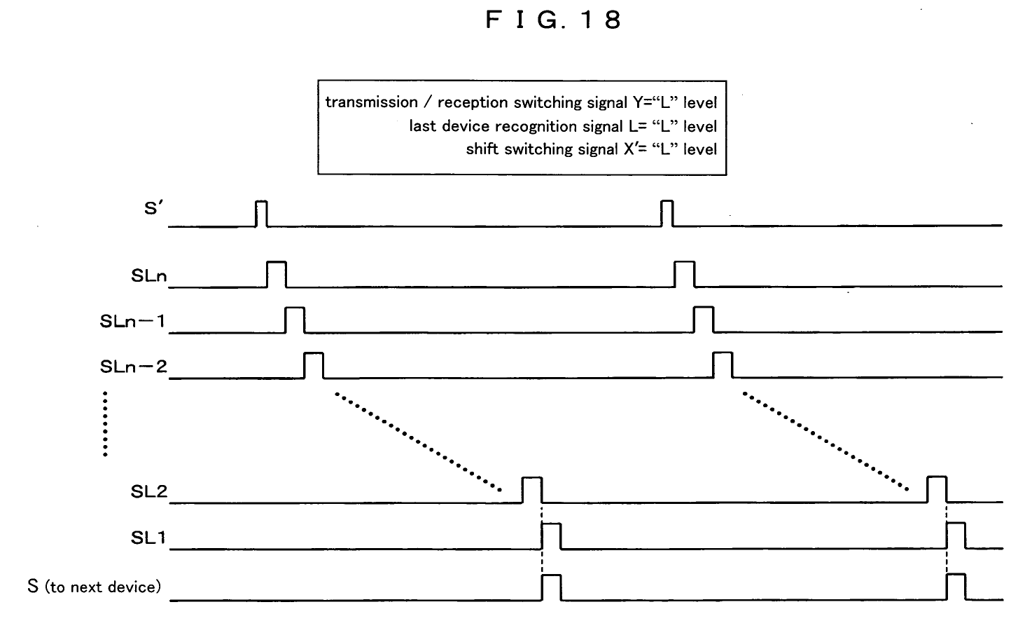

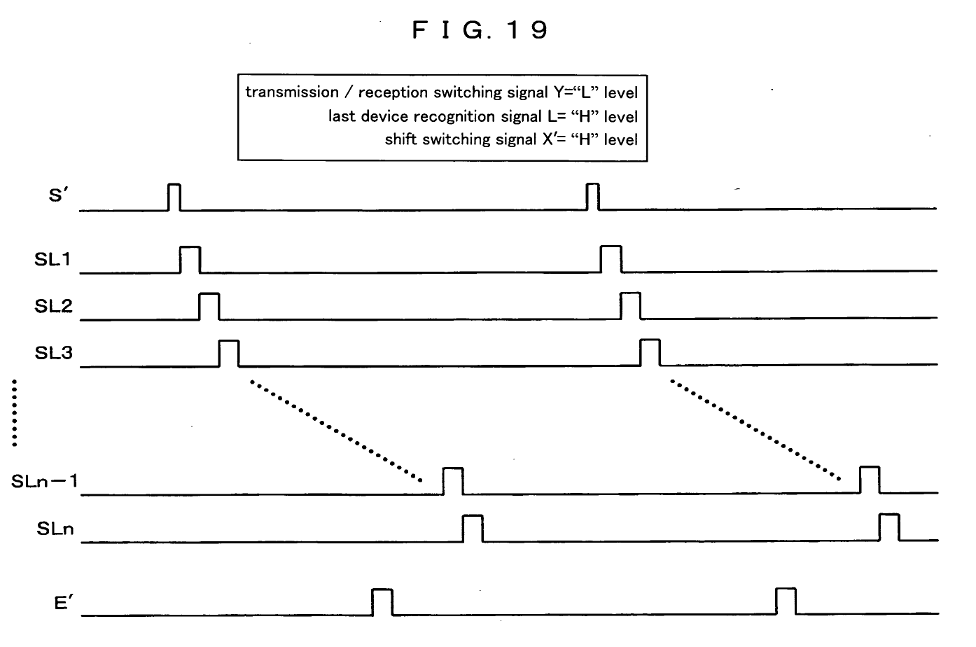

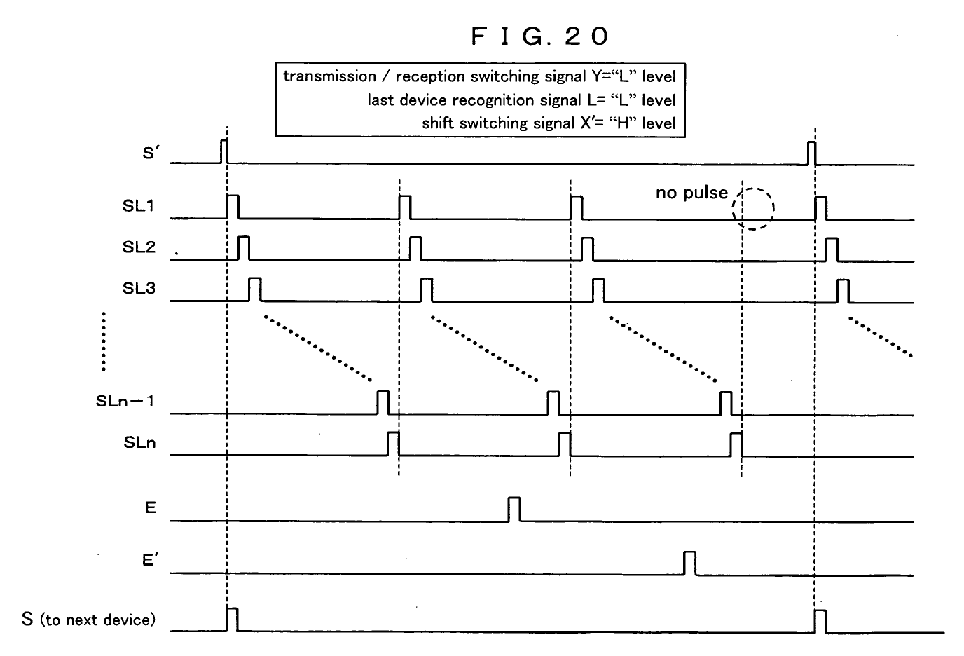

FIGS. 18, 19 and 20 are timing charts relating to the operation of the display panel drive devices B1, B2 and B3 in the second group of display panel drive devices. FIG. 18 is a timing chart of the forward-direction fetching operation by the display panel drive devices B2 and B3, other than the last display panel drive device. FIG. 19 is a timing chart in the reverse-direction fetching operation by the last display panel drive device B1. FIG. 20 is a timing chart of the reverse-direction fetching operation by the display panel drive devices B2 and B3, other than the last display panel drive device. In FIGS. 18-20, the transmission/reception switching signal Y is set to “L” level so that the selector SE11 selects the start signal S′ in the first control shift circuit T11 shown in FIG. 13. In the second control shift circuit T12 shown in FIG. 14, the AND gates a21 and a22 are in the OFF state.

1) Forward-Direction Fetching Operation Mode

FIG. 18 is a timing chart of the operation of the display panel drive devices B2 and B3 in the forward-direction fetching operation. In this case, the transmission/reception switching signal Y is set to “L” level, the last device recognition signal L is set to “L” level, and the shift switching signal X′ is set to “L” level. The operation shown in FIG. 18 is opposite to the same of the display panel drive devices A1 and A2 shown in FIG. 15 in the first group of display panel drive devices.

The shift register 12 generates the latch signals for fetching the display data D into the latch circuit 13 up to the latch signals SLn-SL1 after the reception of the start signal S′. At the time, the operation of the shift register 12 is temporarily halted after the latch signal SL1 is outputted, and the shift register 12 is not operated until the next start signal S1 is inputted. The generated latch signal SL1 is transmitted from the first transmitter/receiver Q1 as the start signal S with respect to the next device.

Though a timing chart is omitted, the first transmitter/receiver Q1 does not transmit the latch signal SL1 as the start signal S corresponding to the next device when the last device recognition signal L is at “H” level. However, the operations of the display panel drive devices B2 and B3 are executed in a manner similar to the foregoing description except that the first transmitter/receiver Q1 does not transmit the latch signal SL1.

2) Reverse-Direction Fetching Operation Mode

FIG. 19 is a timing chart illustrating the operation of the last display panel drive device B1 in the reverse-direction fetching operation mode. In this case, the transmission/reception switching signal Y is set to “L” level, the last device recognition signal L is set to “H” level, and the shift switching signal X′ is set to “H” level. The operation shown in FIG. 19 is opposite to the same of the display panel drive device A3 shown in FIG. 16 in the first group of display panel drive devices.

The shift register 12 generates the latch signals for fetching the display data D into the latch circuit 13 up to the latch signals SLn-SL1 after the reception of the start signal S′. At the time, the operation of the shift register 12 is temporarily halted after the latch signal SLn is outputted, and the shift register 12 is not operated until the next start signal S′ is inputted. The latch signal earlier than the latch signal SLn by a few signals is transmitted from the second transmitter/receiver Q2 as the enable signal E′.

FIG. 20 is a timing chart illustrating the operations of the display panel drive devices B2 and B3, other than the last display panel drive device, in the reverse-direction fetching operation mode. In this case, the transmission/reception switching signal Y is set to “L” level, the last device recognition signal L is set to “L” level, and the shift switching signal X′ is set to “H” level. The operation shown in FIG. 20 is opposite to the same of the display panel drive devices A1 and A2 shown in FIG. 17 in the first group of display panel drive devices.

The shift register 12 outputs the latch signals SL1-SLn after the reception of the start signal S′, and outputs again the latch signal SL1-SLn until the enable signal E is inputted. Further, the shift register 12 generates the next latch signals SL1-SLn by which the enable signal E is inputted as the latch signals SL for fetching the display data corresponding to itself, and temporarily halts its operation and does not restart the operation until the next start signal S′ is inputted. The latch signal SL earlier by a few signals than the latch signal SLn at the last position of the latch signals SL1-SLn which is a group of latch signals generated after the enable signal E is inputted is transmitted from the second transmitter/receiver Q2 as the enable signal E′. Further, the signal G5 outputted from the first control shift circuit T11 is transmitted from the first transmitter/receiver Q1 as the start signal S with respect to the next device.

Accordingly, the generation of the latch signals for sequentially fetching the display data D from the first display panel drive device AB to the last display panel drive device AB and the generation of the latch signals for sequentially fetching the display data D from the last display panel drive device AB to the first display panel drive device AB can be realized. Further, because the transmission/reception switching function is also provided, the signals outputted from the controller 2 can be received by either the first transmitter/receiver Q1 or the second transmitter/receiver Q2 and transmitted in the cascade manner.

In the foregoing description, the latch signal SL earlier by a few signals than the latch signal SL1 is used as the enable signal E, and the latch signal SL earlier by a few signals than the latch signal SLn is used as the enable signal E′. However, the positions at which the enable signals E and E′ are outputted are not necessarily fixed.

In the foregoing description, the latch signal SLn or the signal G5 outputted from the first control shift circuit T11 is used as the start signal S′ corresponding to the next device, and the latch signal SL1 or the signal G5 outputted from the first control shift circuit T11 is used as the start signal S corresponding to the next device. However, such a combination of signals is largely different depending on how the display data D is synchronized. Therefore, the combination of signals is not particularly limited as far as the timings of the display data D and the latch signal SL are synchronized.

The constitutions described so far are largely different depending on the combination of the logical circuits. Any circuit configuration capable of obtaining a similar effect can be adopted without any limitation.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A panel display device comprising:
a display panel;
a plurality of display panel drive devices cascade-connected to the display panel so as to drive-control the display panel; and
a controller for sequentially transmitting display data to the plurality of display panel drive devices, wherein
the plurality of display panel drive devices can switch between a forward-direction fetching operation mode for sequentially fetching the display data into the respective display panel drive devices along a forward direction of the plurality of display panel drive devices placed in parallel and a reverse-direction fetching operation mode for sequentially fetching the display data along a reverse direction of the plurality of display panel drive devices placed in parallel,
any of the display panel drive devices other than the last display panel drive device fetches the display data addressed to itself in response to the reception of a start signal from outside or the previous display panel drive device and transmits the start signal to the immediately subsequent display panel drive device in the forward direction in the forward-direction fetching operation mode,
the last display panel drive device fetches the display data addressed to itself in response the reception of the start signal in the forward-direction fetching operation mode,
any of the display panel drive devices other than the last display panel drive device fetches the display data addressed to itself in response to the reception of the start signal from outside or the previous display panel drive device and transmits the start signal to the immediately subsequent display panel drive device in the forward direction in the reverse-direction fetching operation mode,
the last display panel drive device fetches the display data addressed to itself in response the reception of the start signal and transmits an enable signal to the immediately preceding display panel drive device in the reverse direction in the reverse-direction fetching operation mode, and
any of the display panel drive devices other than the last display panel drive device fetches the display data addressed to itself in response to the reception of the enable signal and transmits the enable signal to the immediately preceding display panel drive device in the reverse direction in the reverse-direction fetching operation mode.

2. The panel display device as claimed in claim 1, wherein
the controller outputs a shift switching signal for switching between the forward-direction fetching operation mode and the reverse-direction fetching operation mode to the respective display panel drive devices.

3. The panel display device as claimed in claim 1, wherein
the controller outputs a last device recognition signal showing if each of the display panel drive devices is the last display panel drive device which receives the display data, taking aim at each of the plurality of display panel drive devices.

4. The panel display device as claimed in claim 3, wherein
the last device recognition signal is set to “H” level or “L” level for each of the display panel drive devices.

5. The panel display device as claimed in claim 3, wherein
the controller outputs the last device recognition signal to the respective display panel drive devices.

6. The panel display device as claimed in claim 1, wherein
the controller simultaneously transmits the display data of a plurality of channels as the display data and outputs a first device recognition signal showing if each of the display panel drive device is the first display panel drive device which receives the display data, taking aim at each of the plurality of display panel drive devices, and
the display panel drive device in which the asserted first device recognition signal is set transmits the received display data of the plurality of channels to the next display panel drive device in a timing different from one another.

7. The panel display device as claimed in claim 6, wherein
the first device recognition signal is set to “H” level or “L” level by each of the display panel drive devices.

8. The panel display device as claimed in claim 6, wherein the controller outputs the first device recognition signal to the respective display panel drive devices.

9. The panel display device as claimed in claim 1, wherein
the plurality of display panel drive devices each comprises a plurality of groups of display panel drive devices each cascade-connected to the display panel, wherein
the plurality of groups of display panel drive devices can be independently operated.

10. The panel display device as claimed in claim 9, wherein
the plurality of groups of display panel drive devices are symmetrically placed with respect to the display panel.

11. The panel display device as claimed in claim 10, wherein
the controller outputs a shift switching signal for switching between the forward-direction fetching operation mode and the reverse-direction fetching operation mode, a last device recognition signal showing if each of the plurality of display panel drive devices is the last display panel drive device which receives the display data, taking aim at each of the plurality of display panel drive devices, and a transmission/reception switching signal to the respective display panel drive devices, and
the plurality of groups of display panel drive devices have a common constitution and are controlled by the shift switching signal, the last device recognition signal and the transmission/reception switching signal.

12. The panel display device as claimed in claim 1, wherein
the plurality of display panel drive devices each comprises:
a first transmitter/receiver for transmitting and receiving the various signals in the forward direction;
a second transmitter/receiver for transmitting and receiving the various signals in the reverse direction;
a shift register for generating a plurality of latch signals for fetching the display data; and
a latch circuit for fetching the display data based on the latch signals from the shift register, wherein
each of the plurality of display panel drive devices fetches the display data based on the latch signals for the first through last devices, makes the shift register operate based on the signals received by the first transmitter/receiver, and fetches the display data based on the latch signals for the last through first devices when the shift register generates the latch signals for the first through last devices based on the signals received by the first transmitters/receivers.

13. The panel display device as claimed in claim 12, wherein
the controller outputs a transmission/reception switching signal for switching between of transmission and reception as a role of each of the first and second transmitters/receivers, taking aim at each of the plurality of display panel drive devices.

14. The panel display device as claimed in claim 13, wherein
the transmission/reception switching signal is set to “H” level or “L” level for each of the display panel drive devices.

15. The panel display device as claimed in claim 13, wherein
the controller outputs the transmission/reception switching signal to the respective display panel drive devices.
